(19) United States
(12) Patent Application Publication
(10) Pub. No.: US 2024/0262081 A1
(43) Pub. Date: Aug. 8, 2024

(54) Cooking Utensil And Method Of Making The Same

(71) Applicant: All-Clad Metalcrafters LLC, Canonsburg, PA (US)

(72) Inventors: William A. Groll, McMurray, PA (US); Nicole Rae Christy, Wheeling, WV (US)

(73) Assignee: All-Clad Metalcrafters LLC, Canonsburg, PA (US)

(21) Appl. No.: 18/428,919

(22) Filed: Jan. 31, 2024

Related U.S. Application Data
(60) Provisional application No. 63/443,568, filed on Feb. 6, 2023.

(51) Int. Cl. B32B 15/085; A47J 27/00; A47J 36/02; B32B 15/18; B32B 27/20; B32B 27/32; B32B 37/06; B32B 37/10

(52) U.S. Cl. CPC B32B 15/085; A47J 27/002; A47J 36/025; B32B 15/18; B32B 27/20; B32B 27/322; B32B 37/06; B32B 37/10; B32B 2250/02; B32B 2305/30; B32B 2307/7376; B32B 2307/748; B32B 2309/02; B32B 2309/04; B32B 2309/105; B32B 2309/12; B32B 2311/30; B32B 2327/18; B32B 2509/00

(57) ABSTRACT

A method of making a cooking utensil and a cooking utensil made using the same. In some embodiments, a method of making a cooking utensil includes applying pressure and heat to a multilayer stack to form a laminate, the multilayer stack including a metal substrate and a first polymer film.

### CROSS-REFERENCE TO RELATED APPLICATIONS

This application claims the benefit of the filing date of U.S. Provisional Patent Application No. 63/443568 filed Feb. 6, 2023, the disclosure of which is hereby incorporated by reference.

### BACKGROUND

Some cooking utensils, such as frying pans and others, intended to be used on a cooking hob, such as cooking parts of electrical cooking appliances, for instance cooking vats or cooking plates, or baking utensils intended to be used in an oven, require a non-stick surface to prevent food from sticking to the cooking surface. The non-stick surface is typically polytetrafluoroethylene (PTFE) or another type of polymer with non-stick properties, which overlies a metal substrate.

Conventionally, non-stick surfaces are applied using a spray coating process. However, non-stick surfaces which are applied by a spray coating process can be porous and uneven in thickness because the spray coating process uses a solvent which then must be evaporated, reducing density and forming pores in the resulting non-stick coating. The porosity of the non-stick coating can result in grease, oil, and other food products being trapped in the pores of the non-stick coating. These trapped oils and food products may the polymerize when the utensil is next heated, resulting in rapid degradation of the non-stick property. Spray coating also introduces limitations in the thickness of the coating that can be applied. For example, a spray coating can typically be applied to a thickness of only about 0.001 inches to about 0.002 inches. The thickness of a spray-coated layer is limited because, if it rises too high, e.g. above 0.002 inches, solvent becomes trapped within voids of the layer and is not evaporated. This is an issue because non-stick surfaces are susceptible to scratching by knives, forks, metal spatulas, or other instruments used during cooking. Limited thickness provides reduced protection and resilience against such damage and also limits opportunities for restoration of the non-stick properties of the utensil by resurfacing of the damaged non-stick film. Further, trapped solvent can cause lowered adhesion of the non-stick coating resulting in bubbling and peeling. Finally, when the spray coating is applied after shaping the cooking utensil which can result in an uneven distribution of coating, particularly in the corners and sidewalls of the cooking utensil.

In some cases, an high impact bonding method (“HIB” or “impact bonding”) may also be used to apply non-stick coatings to a metal substrate. In a typical high impact bonding process, an uncoated metal substrate is laid on a platen or plate (e.g. a bottom platen). A prefabricated polymer non-stick film is attached to an opposing platen (e.g. upper platen), which is spaced apart from the platen holding the metal substrate. The metal substrate is heated via its platen (typically to a temperature of around 425° C. to around 485° C., while the non-stick film is not. Once the metal substrate is sufficiently heated, the two platens are rapidly brought together with force for a time period of several seconds, e.g. 1-10 seconds, to bond the non-stick film to the metal substrate.

While HIB methods may alleviate some of the porosity issues attendant to spray coating methods, it is still difficult or impossible to produce high thickness non-stick coatings using these methods. Since the bonding and transfer time is extremely short (e.g. only 10 seconds or fewer), it is difficult to achieve sufficient heat transfer through a thicker polymer film to effectively bond it to the metal substrate. Further, the extremely short bonding period limits precision in control of temperature, pressure, and other bonding conditions and makes it more difficult to assemble larger and more complex assemblies of layers. HIB methods may also be unable to bond non-stick coatings to certain materials (e.g. stainless steel) for these reasons.

Accordingly, there is a need in the art for a method of making a non-stick cooking utensil which allows for production of thicker polymer layers with lower porosity, for precise control of process conditions, for good adherence of layers to a variety of metal substrates, and for assembly of various sizes and numbers of layers.

### BRIEF SUMMARY

A method of making a non-stick cooking utensil including a laminate and a non-stick cooking utensil made using the same are disclosed herein.

In some aspects, the method may include forming a multilayer stack comprising a non-stick film and a metal substrate, applying pressure to the multilayer stack at room temperature, subsequently heating the entire multilayer stack to form a laminate, and shaping the laminate into the cooking utensil or a portion thereof. In some embodiments, the pressure may be applied in a thickness direction of the multilayer stack and may also be applied within a range of about 50 bar to about 1000 bar. In some embodiments, the pressure may be applied by a pressure fixture or jig.

In some embodiments, the multilayer stack may be heated to a lamination temperature of about 250 degrees Celsius to about 500 degrees Celsius. In some embodiments, the heating may be conducted for a period of about 90 minutes to about 810 minutes. In some embodiments, the heating may be conducted for a period of about 120 minutes to about 780 minutes.

In some aspects, the method may further include preparing the non-stick film by a casting method a cutting method, a calandering method, or an extrusion method; and then including the non-stick film in the multilayer stack.

In some embodiments, the metal substrate may include stainless steel and the non-stick film comprises PTFE and a filler.

In some embodiments, no mesh layer is included in the multilayer stack.

The present disclosure also provides a cooking utensil, including a laminate comprising a stainless steel substrate directly bonded to a non-stick film, wherein the non-stick film has a thickness greater than 0.002 inches to less than 0.015 inches. In some embodiments, the thickness of the non-stick film may be from about 0.003 inches to about 0.009 inches. In some embodiments, the non-stick film may be non-porous. In some embodiments, the non-stick film may be free from solvent.

In some embodiments, no mesh layer is included in the non-stick film.

In some embodiments, the non-stick film may include PTFE and a filler.

Also provided is a method of making a laminate for a cooking utensil, which can include forming a plurality of multilayer stacks, each comprising a non-stick film and a metal substrate; stacking the plurality of multilayer stacks in a thickness direction and providing a separator comprising a stainless steel disc between adjacent multilayer stacks;

applying pressure to the plurality of multilayer stacks at room temperature; and subsequently heating the plurality of multilayer stacks to form each multilayer stack into a laminate.

In some embodiments, the pressure applied may be within a range of about 50 bar to about 1000 bar. In some embodiments, the heating may be conducted for a period of about 90 minutes to about 810 minutes. In some embodiments, the separator may further include a coating layer comprising at least one of a ceramic or a polyimide.

### BRIEF DESCRIPTION OF THE DRAWINGS

FIG. 1A is a schematic cross-sectional view of multilayer stack(s) before lamination, in accordance with some embodiments of the present disclosure.

FIG. 1B is a schematic cross-sectional view of multilayer stack(s) after lamination, in accordance with some embodiments of the present disclosure.

FIG. 2A is a schematic cross-sectional view of multilayer stack(s) before lamination, in accordance with some embodiments of the present disclosure.

FIG. 2B is a schematic cross-sectional view of multilayer stack(s) after lamination, in accordance with some embodiments of the present disclosure.

FIG. 2C is a schematic cross-sectional view of multilayer stack(s) before lamination, in accordance with some embodiments of the present disclosure.

FIG. 2D is a schematic cross-sectional view of multilayer stack(s) after lamination, in accordance with some embodiments of the present disclosure.

FIG. 3A is a schematic cross-sectional view of multilayer stack(s) before lamination, in accordance with some embodiments of the present disclosure.

FIG. 3B is a schematic cross-sectional view of multilayer stack(s) after lamination, in accordance with some embodiments of the present disclosure.

FIG. 3C is a schematic cross-sectional view of multilayer stack(s) before lamination, in accordance with some embodiments of the present disclosure.

FIG. 3D is a schematic cross-sectional view of multilayer stack(s) after lamination, in accordance with some embodiments of the present disclosure.

FIG. 4 is a schematic cross-sectional view of a pressure fixture containing a plurality of multilayer stacks, in accordance with some embodiments of the present disclosure.

FIG. 5A is a schematic cross-sectional view of multilayer stack(s) before lamination, in accordance with some embodiments of the present disclosure.

FIG. 5B is a schematic cross-sectional view of multilayer stack(s) after lamination, in accordance with some embodiments of the present disclosure.

FIG. 5C is a schematic cross-sectional view of multilayer stack(s) before lamination, in accordance with some embodiments of the present disclosure.

FIG. 5D is a schematic cross-sectional view of multilayer stack(s) after lamination, in accordance with some embodiments of the present disclosure.

### DETAILED DESCRIPTION

A method of making a cook utensil and a cooking utensil made from the same are disclosed herein.

The term “overlying” as used herein means “above, but not necessarily contacting”. For example, a first polymer film overlying a metal substrate means the first polymer film is above the metal substrate, but there may be or may not be an intervening layer between the first polymer film and the metal substrate.

In the present disclosure, the term “cooking utensil” can refer to any implement used to transfer heat to ingredients in the cooking and preparing of food, such as a pot, pan, a vat, an appliance, or the like.

As used herein, the “cooking surface” is the surface of the cooking utensil configured to contact food or other ingredients. The “heating surface” is the surface opposing the “cooking surface”, which is typically in contact with a heat surface during the cooking process.

In the present disclosure, “length” is the longest dimension of an object in a horizontal or x-y plane. “Width” is the shortest dimension in the same plane. “Thickness” refers to the dimension of the objection in a direction normal to the length-width plane.

In the present disclosure, “room temperature” refers to a temperature of about 20° C. to about 25° C., e.g. about 21° C., about 22° C., about 23° C., about 24° C., etc.

In the present disclosure, “bonding surface” refers to a surface of a film, layer, or substrate configured to bond to another film, layer, or substrate, e.g. during a lamination process.

In the present disclosure, a “multilayered stack” refers to a stack of at least one non-stick polymer film and at least one metal substrate layer, configured to form the body and surfaces of one cooking utensil. Multiple multilayered stacks refer to stacks which will form multiple cooking utensils, i.e. with each multilayered stack corresponding to one individual cooking utensil.

In the present disclosure, when the term “based” is used to describe composition (e.g. “PTFE-based”, “polymer based”), the term indicates that the preceding term or phrase makes up the majority of, or substantially all of, the described composition or component.

### Method of Making a Non-Stick Cooking Utensil

A method of making the cooking utensil of the present disclosure includes forming a multilayer stack, applying pressure to the multilayer stack, heating the pressurized multilayer stack to laminate the multilayer stack, and shaping the laminated multilayer stack into a cooking utensil.

### Formation of Multilayer Stack

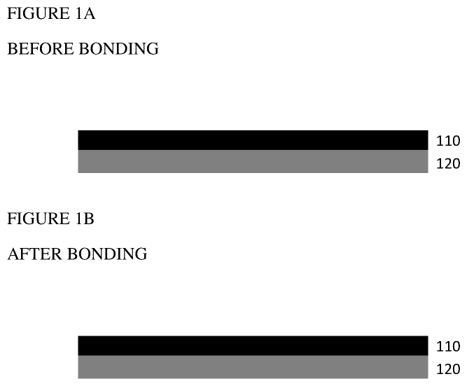

Initially, the multilayer stack is formed by stacking at least one prefabricated non-stick polymer film 110 and at least one metal substrate layer 120, as shown in FIGS. 1A-1B. The multilayer stack is formed with all layers in an unheated state and/or with all layers at room temperature. The order of stacking is not particularly limited, and the non-stick film may overlie the metal substrate layer, or vice versa. The stack may be in any suitable shape (when viewed in the direction of thickness of the stack) that is convenient for molding or shaping the stack into a cooking utensil. Suitable shapes may include circular, square, rectangular, or the like.

In some embodiments in which a pressure fixture or jig including two platens or plates is used in the method, the multilayer stack may be formed by stacking at least one prefabricated non-stick polymer film and at least one metal substrate layer on the lower of the two platens. In such an embodiment, none of the platens are heated and are all at room temperature during the formation of the multilayer stack.

The non-stick film provided during the formation of the multilayer stack is a free-standing prefabricated non-stick film. Appropriate films may be fabricated by various different methods such as a casting method or a cutting method, wherein the cutting method can include skiving, an extrusion method, and a calendaring method. In some aspects, the multilayer stack of the disclosed method does not include any non-stick films fabricated in situ, e.g. films produced by spray coating, as these films are highly porous, low in density, low in thickness, and are not free-standing.

The non-stick film provided in the multilayer stack may have a thickness of about 0.001 inches to about 0.02 inches, more preferably from greater than 0.002 inches to less than 0.015 inches, even more preferably from about 0.003 inches to about 0.009 inches. In a preferred embodiment, the non-stick film has a thickness of about 0.005 inches. If the non-stick film is too thin (e.g. 0.002 inches or less), it may produce a non-stick utensil which is less resilient against scratching and gouging and whose non-stick surface may be unsuitable for resurfacing once this damage does occur. There is no significant upper limit to the thickness of the non-stick film which may be used in the disclosed process. However, if the non-stick film is too thick (e.g. 0.15 inches or more), it may result in a utensil whose non-stick surface inhibits and prevents adequate heat transfer during cooking.

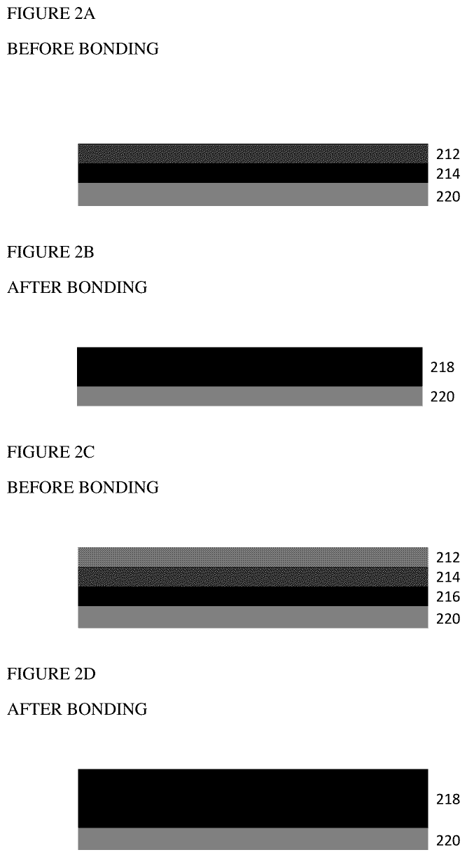

The non-stick polymer film may be single layer, as shown in FIG. 1, or multilayer, as shown in FIGS. 2-3 and 5. For example, as shown in FIGS. 2A-2B, first and second polymer films 212, 214 may be included in the multilayered stack along with the metal substrate 220. These may be bonded to form a composite multilayer polymer film 218 after lamination. Similarly, as shown in FIGS. 2C-2D, first, second, and third polymer films 212, 214, 216 may be included in the multilayered stack along with the metal substrate 220. These may be bonded to form a composite multilayer polymer film 218 after lamination. Regardless of the number of layers, the total thickness of the non-stick film is within the limits specified above. For example, in a multilayer embodiment, the sum of the thicknesses of the layers may be within 0.001 inches to about 0.02 inches, greater than 0.002 inches to less than 0.015 inches, about 0.003 inches to about 0.009 inches, about 0.004 inches to about 0.008 inches, etc. Similarly, in a single layer embodiment, the thickness of the single layer may be within 0.001 inches to about 0.02 inches, greater than 0.002 inches to less than 0.015 inches, about 0.003 inches to about 0.009 inches, about 0.004 inches to about 0.008 inches, etc.

Conventionally, non-stick films were manufactured by a spray coating process. Thickness was limited (e.g. to about 0.001 inches to about 0.002 inches) with such films because with spray-coated films, as thickness increases, residual solvent tends to become trapped in the film and cannot evaporate during the evaporation process, resulting in a solvent contaminated film. Because spray coating is not used to fabricate the film of the present disclosure, a high thickness film (e.g. 0.002 inches or more) can be achieved without any worry of solvent contamination.

The polymer of the non-stick film may be any suitable polymer that can be used to create a non-stick surface. In some aspects, the polymer film comprises one or more of selected from the group consisting of polytetrafluoroethylene (PTFE), tetrafluoroethylene-hexafluoropropylene copolymer (FEP), tetrafluoroethylene-perfluoroalkyl vinyl ether (PFA), ethylenetetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE) and ethylene-chlorotrifluoroethylene copolymer (ECTEF), polyether ether ketone (PEEK), polyaryletherketone (PAEK), or combinations thereof. In some embodiments, the polymer film is PTFE.

The non-stick film and its layer(s) may be pure polymer or may include additives. The additives may be one or more of fillers, colorants. Appropriate fillers include one or more of glass fillers, quartz fillers, graphite fillers, mica fillers, powdered carbon (e.g. carbon black) fillers, bronze fillers, and hybrid fillers, such as elemental carbon mixed with graphite. A preferred additive includes a carbon type filler or colorant which makes the non-stick film black. The amount of filler and/or colorant can vary depending on the attributes that are trying to be achieved. Too high of a percentage added can cause issues with formability, ductility, etc. However, too low of a percentage can cause issues such as uneven coloring, or the filler not providing any benefit, etc. Accordingly, types and amounts of additives must be carefully selected.

In embodiments in which the non-stick film is multilayer, layers may have the same composition, or may differ in composition. For example, a top layer (i.e. configured to form a cooking surface, furthest from the metal substrate) may be a PTFE-based layer, while one or more intervening layers between the top layer and the metal substrate may include or be based on different polymer components (e.g. PFA, FEP, PEEK). In one embodiment, the top layer may be PTFE-based, while a lower layer may be FEP-based. In this embodiment, the FEP-based layer may enhance adhesion between metal substrate and the PTFE-based top layer (although this is not its only function). Accordingly, various different compositions and combinations of layers may be selected based on their properties and on design constraints. In a preferred multilayer embodiment, the non-stick film includes a top layer of PTFE with a filler (e.g. a carbon type filler) and a second lower layer of PTFE lacking a filler (which in some embodiments, may be pure PTFE). This configuration takes advantage of the properties of both the filler and PTFE. The addition of filler helps to strengthen the PTFE and may also impart color. However, addition of filler can result in more difficult bonding properties, given that the filler molecules generally do not participate in bonding to the metal substrate or other layers. Accordingly, a filler-free layer may be used against a metal substrate in order to maximize bonding, while a filled layer may be used on top, in order to strengthen and color the PTFE at the cooking surface.

In an embodiment in which the non-stick film is a single layer, it is preferred that the layer be a PTFE based layer. In some embodiments, this may be a pure PTFE layer. In a most preferred embodiment, this layer is a PTFE layer comprising a carbon type filler to impart black color to the layer.

The non-stick film provided in the multilayer stack may contain no voids, or substantially no voids, i.e. is non-porous. Porosity, or lack thereof, may be tested by any known method in the art. In particular, a lack of voids and/or pores may be confirmed by methods such as dye penetrant testing (“dye penetrant inspection (DP)”, “liquid penetrant inspection (LPI)”, “penetrant testing (PT)”) and use of a holiday tester. The non-stick film of the present disclosure displays no or substantially no voids upon dye penetrant inspection and/or does not transmit current upon testing with a holiday tester. Further, the non-stick film provided in the multilayer stack contains no solvent.

Traditional spray-coated films are porous and contain voids because solvent used in the spray coating process must be evaporated, reducing density and forming pores in the resulting non-stick coating. The porosity of the non-stick coating can result in grease, oil, and other food products being trapped in the pores of the non-stick coating, which results in loss of the non-stick property over time. Further, with spray-coated films, as thickness increases, residual solvent tends to become trapped in the film, resulting in a solvent-contaminated film. The disclosed method solves this problem by providing a prefabricated film (i.e. rather than a spray-coated film fabricated in situ), which is substantially non-porous. Further, because spray coating is not used to fabricate the film, a high thickness film (e.g. 0.002 inches or more) may be used, without any presence of residual solvent within the film.

The metal substrate layer provided in the multilayer stack may be any suitable metal substrate used in a cooking utensil. The metal substrate may be single layer or multilayer. Exemplary metal substrates include solid aluminum, solid stainless steel, solid titanium, carbon steel, a multilayer substrate having a copper core and a stainless steel surface, a multilayer substrate having an aluminum core and a stainless steel surface, a multilayer substrate having an aluminum core and a titanium surface, a multilayer substrate having a copper core and a titanium surface, a multilayer substrate having an aluminum core and a carbon steel surface, a multilayer substrate having a copper core and a carbon steel surface. In some embodiments, the metal substrate may be a multilayer structure including a graphite core, such as described in U.S. Pat. Nos. 10,081,163; 10,717,252; and 11,364,706, and U.S. patent Publication No. 2021/0177195 which are incorporated by reference herein.

The disclosed method may optionally include a step of pretreating a bonding surface of the metal substrate layer, prior to formation of the multilayer stack. The substrate may be pretreated to create texture and increased surface area on the bonding surface of the substrate, for improved bonding to the polymer film. Exemplary pretreatment processes can include chemical etching, grit blasting, belt sanding, arc spraying, and the like.

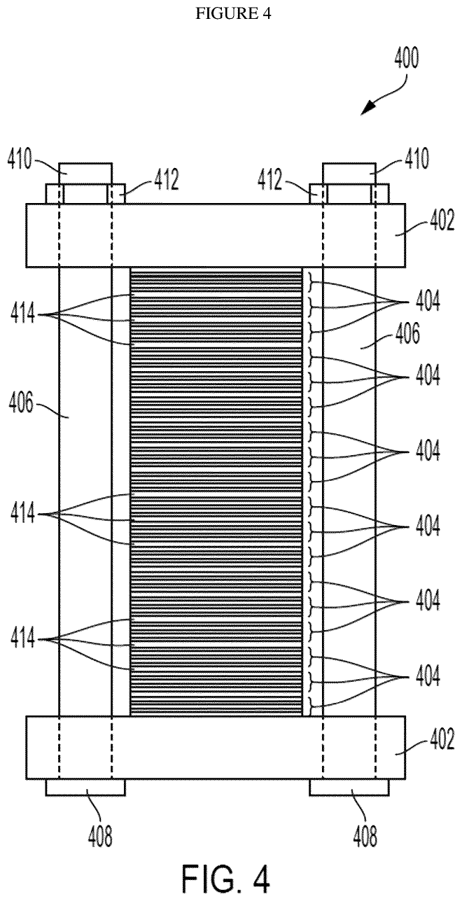

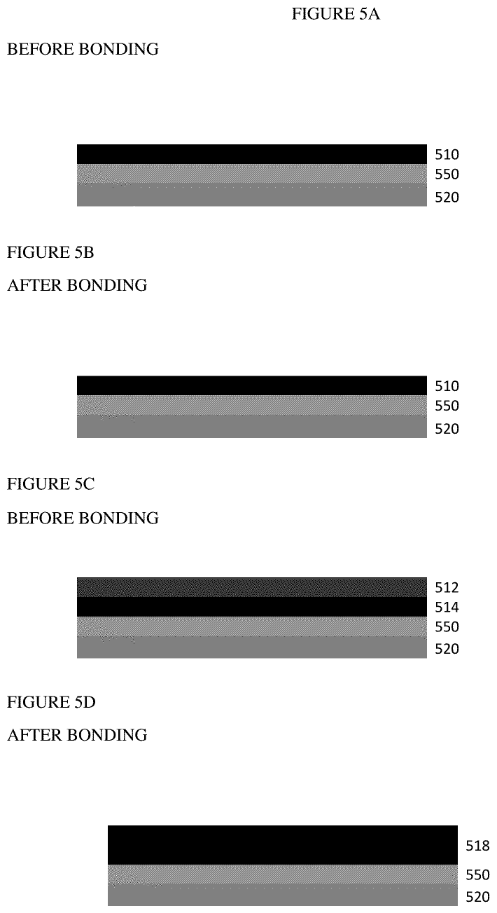

In some embodiments, an additional layer can be provided in the multilayered stack. The additional layer can be one or more of: an inert layer, i.e., a layer which can withstand the pressure and temperature of the subsequent lamination process without laminating to the stack and can be removed from the stack after lamination is complete; a polymer film that becomes a permanent component of the laminated stack; or a metal or non-polymer material that becomes a permanent component of laminated stack, as shown in FIG. 5. The inert layer can include one or more of a ceramic, stainless steel, a polyimide such as KAPTON®, or another material that does not laminate upon pressure and heating with the stack. In an embodiment where multiple multilayer stacks are laminated simultaneously, the inert layer can be a separator 414, as depicted in FIG. 4. When the additional layer is a polymer film, the polymer film may be any suitable polymer discussed herein with regards to the polymer film. When the additional layer is a metal or non-polymer material 550 that becomes a permanent component of the laminated stack, as depicted in FIGS. 5A-5D, in some embodiments, each multilayer stack may additionally include a non-stick film 510 and a metal substrate 520. As depicted in FIGS. 5C-5D, in some embodiments, the non-stick film may include a first polymer film 512 and a second polymer film 514, which is bonded during lamination to form a composite non-stick film 518.

While additional layers such as those described above may be included in the multilayer stack, in a preferred embodiment, no metal mesh, metal web, perforated metal film, or metal grid type layer is included in the multilayer stack.

In some embodiments, the multilayer stack may not contain any glue, adhesive, or other intervening film or layer whose sole purpose is to facilitate bonding between surrounding films or layers. In certain embodiments, the non-stick film is bonded directly to the metal substrate, without any intervening film(s) or layer(s).

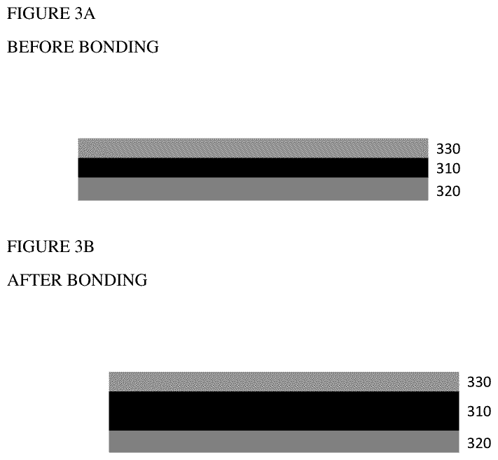

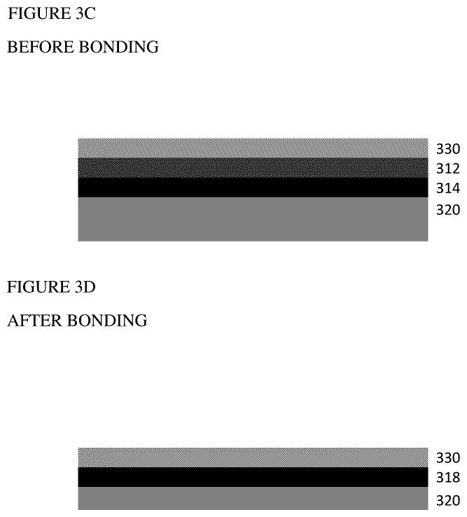

In some embodiments, more than one multilayered stacks may be provided during the formation of the multilayered stack, e.g. two or more, three or more, or four or more multilayered stacks, so as to allow for efficient and simultaneous bonding of numerous stacks and therefore the efficient and simultaneous production of multiple utensils or items of cookware. In the event that more than one multilayered stack is to be bonded, the above-mentioned inert layer may be a separator 330 comprising a stainless steel disc or the like inserted between adjacent stacks during the formation of the multilayered stacks, to prevent bonding between the adjacent stacks, as shown in FIGS. 3A-3D. As depicted in FIGS. 3A-3D, each multilayer stack may include a non-stick film 310 and a metal substrate 320. As depicted in FIGS. 3C-3D, in some embodiments, the non-stick film may include a first polymer film 312 and a second polymer film 314, which is bonded during lamination to form a composite non-stick film 318. To form separators, solid discs of stainless steel placed in between assemblies can be treated with a coating to prevent bonding to the film such as a ceramic, stainless steel, a polyimide such as KAPTON®, or another material that does not laminate upon pressure and heating with the stack. The ability of the disclosed process to stack and subsequently laminate multiple stacks at once is a significant advantage, which is not achievable with impact bonding or HIB methods.

In some embodiments, one or more of the layers in the multilayer stack (i.e. one or more of the non-stick film, the metal substrate, and the additional layer(s)) may have a planar structure. That is, the planar layer(s) are not concave or convex and do not have divots, holes, bubbles, pockets, cavities, or the like. In a preferred embodiment, all of the layers in the multilayer stack are planar. Accordingly, the planar layers may be uniformly bonded across their entire adjacent surfaces during the lamination process.

### Application of Pressure

After the multilayered stack is formed, pressure is applied to the formed stack. The pressure is applied in a direction normal to the thickness of the multilayer stack. The pressure applied can range from about 50 bar to about 1,000 bar, preferably about 100 to about 1,000 bar, or more preferably from about 150 to about 1,000 bar. If too low a pressure is applied, adequate bonding may not be achieved, and/or the process may not allow for bonding between a wide variety of materials. Conversely, if the pressure applied is too high, materials of the multilayer stack, e.g. the non-stick film or other polymer layers, can thin considerably and push out the sides of the stack.

The above-mentioned pressure is applied with the stack at room temperature, prior to any heating step.

In a preferred embodiment, pressure may be applied using a pressure fixture or jig 400 depicted in FIG. 4. However, the methods of present disclosure are not limited to a pressure fixture or jig, and any method of applying sufficient pressure can be utilized. The pressure fixture or jig 400 is useful in applying an axial clamping pressure to the one or more multilayer stacks 404 (several multilayer stacks are depicted in FIGS. 1-3 and 5). The fixture comprises two opposed heavy platens or plates 402 for engaging the respective upper and lower stacks 404 in the array of stacks 404. A plurality of heavy duty bolts 406 are fitted in holes spaced around the periphery of the platens. The bolts have headed portions 408 at one end and opposed threaded ends 410 to receive nuts 412 which, when tightened, force the platens together so as to apply a force in an axial direction, normal to the stacks in the array of stacks situated between the opposed platens 402. In an embodiment in which multiple stacks are formed and laminated simultaneously, each of the stacks 404 may have a separator 414 comprising, e.g. a solid disc of stainless steel or the like, placed therebetween to prevent bonding between the adjacent blank assemblies 404. In some preferred embodiments, four, six, or eight bolts 406 are used to apply the bonding pressure. Double nuts 412 may be used at each bolt end to ensure proper strength.

### Lamination Process

After the pressure is applied at room temperature, heat can be applied to laminate the stack in a lamination process. The lamination process (a pressure bonding process) includes applying pressure and temperature to the multilayer stack to bond and/or laminate the components of the stack to form a laminate including a non-stick film bonded to a metal substrate. Heat may be applied to the previously pressurized multilayer stack by conventional means, such as a furnace, oven, induction, or the like.

To carry out effective lamination, the entire multilayer stack (i.e. all of the layers) is simultaneously heated to a lamination temperature from about 250 degrees Celsius to about 500 degrees Celsius, more preferably from about 275 degrees Celsius to about 475 degrees Celsius, and most preferably from about 300 degrees Celsius to about 450 degrees Celsius. In a preferred embodiment, the multilayer stack is heated to within a range of about 350 degrees Celsius and 425 degrees Celsius. If too low a temperature is applied, adequate bonding may not be achieved, and/or the process may not allow for bonding between a wide variety of materials. Conversely, if the temperature applied is too high, the polymer film(s) of the stack may be damaged beyond usability.

Once the pressure is applied at room temperature, and the multilayer stack has been heated to the appropriate lamination temperature, combination of pressure and temperature may be applied for a total time of about 90 minutes to about 810 minutes, more preferably from about 120 minutes to about 780 minutes, and most preferably from about 150 minutes to about 750 minutes. In a preferred embodiment, the pressure and temperature are applied for about 300 minutes to about 720 minutes. If lamination is not conducted for a long enough time, adequate bonding may not be achieved, and/or the process may not allow for bonding between a wide variety of materials. Conversely, if the lamination time is too long, materials in the layers (i.e. particularly the non-stick and polymer containing layers) may be damaged.

More particularly, during the lamination process, the multilayer stack goes through a ramp up stage, in which it is brought from room temperature to a lamination temperature. The ramp up stage may last from about 80 minutes to about 600 minutes, more preferably from about 80 minutes to about 500 minutes, and most preferably from about 80 minutes to about 400 minutes. During the ramp up stage, the rate of temperature increase of the multilayer stack, i.e. the heating rate, may be within the range of about 0.4° C./min to about 6.3° C./min, preferably between about 0.5° C./min to about 5.9° C./min, and more preferably between about 0.6° C./min to about 5.6° C./min. The ramp up process must be conducted slowly enough to allow for even heating of the entire multilayer stack, without significant temperature gradients or hot spots which could cause damage or extrusion of the polymer layers in particular. The appropriate time and heating rate must be carefully selected and is dependent on numerous factors, including at least the diameter of the multilayer stacks, the total mass being heated, the number or multilayer stacks, their materials, etc.

Once the ramp up stage is complete and the multilayer stack is evenly heated to the lamination temperature, it is then maintained at that temperature for about 10 minutes to about 120 minutes, more preferably for about 30 minutes to about 90 minutes, and most preferably from about 60 minutes to about 90 minutes. An appropriate amount of time maintained at the lamination temperature allows for adequate bonding of diverse materials, while avoiding material damage or undesirable deformation.

The long heating and lamination time of the disclosed method provides numerous advantages over impact bonding or HIB methods. In HIB bonding only the metal substrate is heated-not the non-stick film. Then, the heated metal substrate and the non-stick film are brought together forcefully for only several seconds. Thus, rather than occurring over the course of minutes to hours, as in the disclosed method, heat transfer to the non-stick film must occur rapidly in mere seconds. This limits the achievable thickness of the non-stick film as well as its overall size, since too great a thickness or size may not be possible to adequately heat within the necessary several second time window. More specifically, a thicker layer may create greater variability in heat transfer, which makes it harder to control assembly conditions, making it difficult or impossible to achieve adequate bonding in the rapid time period of HIB methods. In addition, larger diameter discs of films may make it more difficult to properly distribute heat during a production process in which mere seconds are provided to administer heat and pressure. Further, the longer, slower bonding process of the disclosed method allows for adjustment of temperatures, pressures, heating rate, etc. throughout the process in a way that is impossible when bonding is done in seconds. This provides for more precise process controls and tailoring of the lamination process to the materials used. Finally, the long, slow lamination process may allow for the direct bonding of layers (e.g. polymer and metal layers) without the need for a glue, adhesive, or any other intervening layer whose sole purpose is to facilitate bonding.

These limitations on size and control of the bonding process also make it difficult or impossible for multilayer non-stick films (in which different layers have different compositions) to be bonded all at once, using HIB methods. In contrast, the disclosed method allows for wide variation and flexibility in choice of different combinations of layers in different compositions. Thus, multiple different layers may be selected based on their properties (e.g. color, adhesion, strength, resilience, etc.) and effectively laminated together simultaneously using the disclosed method.

Similarly, the longer and slower lamination process allows for wider applicability of the process to different types of material, while HIB methods may only work for very specific types and combinations of materials. For example, HIB methods may not work to directly bond filled PTFE layers and stainless steel, while such direct bonding is possible with the disclosed methods. In HIB methods, it is typically more feasible to bond substantially pure PTFE (e.g. PTFE lacking a filler) directly to stainless steel. However, in many cases, pure PTFE may not be preferred, given that it is a cream/white color, which discolors easily and may be less resilient to scratching and damage. Accordingly, PTFE including fillers which impart strength and/or color may be desired. The present method allows for bonding of a filled PTFE directly to stainless steel.

HIB methods may also eventually fail to achieve an adequate bond if too many layers are used. For example, when the non-stick film includes multiple polymer layers, such as two or more, three or more, or four or more layers, HIB methods may have limitations in that it is difficult to transfer sufficient amounts of heat from a heated metal substrate, through multiple polymer layers in the extremely limited amount of time provided by these methods. In contrast, rather than relying on heat transfer from the heated metal component, the present methods simultaneously heat the entire multilayer stack over a much longer time period, allowing the process to be adjusted to allow for bonding of diverse amounts and combinations of layers.

In a preferred embodiment, the heating may be performed in an inert atmosphere, such as nitrogen or the like, or in a vacuum. In some embodiments, the heating is performed in an air atmosphere.

In a preferred embodiment, in which a pressure fixture or jig is used, after the desired clamping pressure is obtained, the fixture and stacked array are moved to a furnace and heated in a normal atmosphere containing oxygen, a protecting atmosphere, or a vacuum to a desired temperature to achieve the bonding between the individual stacks in the stack array. Alternatively, the stacked array may be heated by an induction heating unit which is positioned adjacent to and around the stacked array so as to avoid heating the fixture to high temperatures as would otherwise occur in a furnace.

### Formation of the Cooking Utensil

Once the multilayer stack is laminated, it may be shaped or molded into a cooking utensil by any methods know in the art, such as spinning, hydroforming, hydraulic press, double action press forming, toggle press forming, or the like. The cooking utensil has at least one cooking surface formed by the non-stick film and at least one opposing heating surface formed by the metal substrate. In some embodiments, the cooking utensil further includes sidewalls that surround the cooking surface and extend above the cooking surface.

Optionally, after lamination of the multilayer stack or after shaping of the laminated stack into a cooking utensil, the stack may be cryogenically treated. In some embodiments, the temperature of the cryogenic treatment may be −73.3 degrees Celsius or less. The cryogenic treatment may improve the properties of the polymer film, the metal substrate, or both. The cryogenic treatment is described in U.S. Pat. No. 6,544,669, the entire contents of which is incorporated by reference herein.

### Non-Stick Cooking Utensil

The present disclosure includes a cooking utensil formed by the disclosed process, which comprises a laminate including at least one metal substrate and at least one non-stick film. The cooking utensil includes at least one cooking surface including the non-stick film and at least one opposing heating surface including the metal substrate. In some aspects, the cooking utensil does not include a reinforcement layer designed to reinforce the non-stick film. In such embodiments, the cooking utensil does not include a metal mesh, such as a metal grid, perforated metal, or metal net type layer. In some embodiments, the cooking utensil further includes sidewalls that surround the cooking surface and extend above the cooking surface.

The non-stick film may have a thickness of about 0.001 inches to about 0.02 inches, more preferably from greater than 0.001 inches to about 0.02 inches, more preferably from greater than 0.002 inches to less than 0.015 inches, and even more preferably from about 0.003 inches to about 0.009 inches. In a preferred embodiment, the non-stick film has a thickness of about 0.005 inches. If the non-stick film is too thin (e.g. 0.002 inches or less), it may be less resilient against scratching and gouging and may be unsuitable for resurfacing once this damage does occur. There is no significant upper limit to the thickness of the non-stick film which is achievable via the disclosed process. However, on a practical level, if the non-stick film is too thick (e.g. 0.15 inches or more), it may inhibit and prevent adequate heat transfer during cooking.

The non-stick film may be single layer or multilayer. Regardless of the number of layers, the total thickness of the non-stick film is within the limits specified above. For example, in a multilayer embodiment, the sum of the thicknesses of the layers may be within 0.001 inches to about 0.02 inches, greater than 0.002 inches to less than 0.015 inches, about 0.003 inches to about 0.009 inches, about 0.004 inches to about 0.008 inches, etc. Similarly, in a single layer embodiment, the thickness of the single layer may be within 0.001 inches to about 0.02 inches, greater than 0.002 inches to less than 0.015 inches, about 0.003 inches to about 0.009 inches, about 0.004 inches to about 0.008 inches, etc.

The polymer of the non-stick film may be any suitable polymer that can be used to create a non-stick surface. In some aspects, the polymer layer comprises one or more of selected from the group consisting of polytetrafluoroethylene (PTFE), tetrafluoroethylene-hexafluoropropylene copolymer (FEP), tetrafluoroethylene-perfluoroalkyl vinyl ether (PFA), ethylenetetrafluoroethylene copolymer (ETFE), polychlorotrifluoroethylene (PCTFE), polyvinylidene fluoride (PVDF), polyvinyl fluoride (PVF), tetrafluoroethylene-perfluoropropyl vinyl ether copolymer (TFM), polytetrafluoroethylene-perfluoromethyl vinyl ether copolymer (PFE/PMVE) and ethylene-chlorotrifluoroethylene copolymer (ECTEF), polyether ether ketone (PEEK), polyaryletherketone (PAEK), or combinations thereof. In some embodiments, the polymer film is PTFE.

The non-stick film may be pure polymer or may include additives. The additives may be one or more of fillers and colorants. Appropriate fillers include one or more of glass fillers, quartz fillers, graphite fillers, powdered carbon (e.g. carbon black) fillers, bronze fillers, mica fillers, and hybrid fillers, such as elemental carbon mixed with graphite. A preferred additive includes a carbon type filler or colorant which makes the non-stick film black.

In embodiments in which the non-stick film is multilayer, layers may have the same composition, or may differ in composition. For example, a top layer (i.e. configured to form a cooking surface, furthest from the metal substrate) may be a PTFE-based layer, while one or more intervening layers between the top layer and the metal substrate may include or be based on different polymer components (e.g. PFA, FEP, PEEK). In one embodiment, the top layer may be PTFE-based, while a lower layer may be FEP-based. In this embodiment, the FEP-based layer may enhance adhesion between metal substrate and the PTFE-based top layer. Accordingly, various different compositions and combinations of layers may be selected based on their properties and on design constraints. In a preferred multilayer embodiment, the non-stick film includes a top layer of PTFE with a carbon type filler and a second lower layer of pure PTFE.

In an embodiment in which the non-stick film is a single layer, it is preferred that the layer be a PTFE based layer. In some embodiments, this may be a pure PTFE layer. In a most preferred embodiment, this layer is a PTFE layer comprising a carbon type filler to impart black color to the layer.

The non-stick film may contain no voids, or substantially no voids, i.e. is non-porous. Porosity, or lack thereof, may be tested by any known method in the art. In particular, a lack of voids and/or pores may be confirmed by methods such as dye penetrant testing (“dye penetrant inspection (DP)”, “liquid penetrant inspection (LPI)”, “penetrant testing (PT)”) and use of a holiday tester. The non-stick film of the present disclosure displays no or substantially no voids upon dye penetrant inspection and/or does not transmit current upon testing with a holiday tester. Further, the non-stick film provided in the multilayer stack contains no solvent.

The metal substrate may be any suitable metal substrate used in a cooking utensil. The metal substrate may be single layer or multilayer. Exemplary metal substrates include solid aluminum, solid stainless steel, solid titanium, carbon steel, a multilayer substrate having a copper core and a stainless steel surface, a multilayer substrate having an aluminum core and a stainless steel surface, a multilayer substrate having an aluminum core and a titanium surface, a multilayer substrate having a copper core and a titanium surface, a multilayer substrate having an aluminum core and a carbon steel surface, a multilayer substrate having a copper core and a carbon steel surface. In some embodiments, the metal substrate may be a multilayer structure including a graphite core, such as described in U.S. Pat. Nos. 10,081,163; 10,717,252; and 11,364,706, and U.S. patent Publication No. 2021/0177195 which are incorporated by reference herein.

In some embodiments, an additional layer can be provided in the laminate. The additional layer can be one or more of: an inert layer, i.e., a layer which can withstand the pressure and temperature of the subsequent lamination process without laminating to the stack and can be removed from the stack after lamination is complete; a polymer film that becomes a permanent component of the laminated stack; or a metal or non-polymer material that becomes a permanent component of laminated stack. The inert layer include one or more of a ceramic, stainless steel, a polyimide, such as KAPTON®, or another material that does not laminate upon pressure and heating with the stack. When the additional layer is a polymer film, the polymer film may be any suitable polymer discussed herein with regards to the polymer film.

In some embodiments, there laminate may not contain any glue, adhesive, or other intervening layer whose sole purpose is to facilitate bonding between surrounding layers. In certain embodiments, the non-stick film is bonded directly to the metal substrate, without any intervening layer(s).

While additional layers such as those described above may be included in the laminate, in a preferred embodiment, no metal mesh, metal web, perforated metal film, or metal grid type layer is included in the multilayer stack. Further, in some embodiments, the multilayer stack does not include a reinforcement layer designed to reinforce the non-stick film.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of making a cooking utensil, comprising:
forming a multilayer stack comprising a non-stick film and a metal substrate,
applying pressure to the multilayer stack at room temperature,
subsequently heating the entire multilayer stack to form a laminate,
shaping the laminate into the cooking utensil or a portion thereof.

2. The method of claim 1, where the pressure is applied in a thickness direction of the multilayer stack.

3. The method of claim 1, where the pressure applied is within a range of about 50 bar to about 1000 bar.

4. The method of claim 1, wherein during the heating, the multilayer stack is heated to a lamination temperature of about 250 degrees Celsius to about 500 degrees Celsius.

5. The method of claim 1, wherein the heating is conducted for a period of about 90 minutes to about 810 minutes.

6. The method of claim 4, wherein the heating is conducted for a period of about 120 minutes to about 780 minutes.

7. The method of claim 1, wherein the pressure is applied by a pressure fixture or jig.

8. The method of claim 1, further comprising:
preparing the non-stick film by a casting method a cutting method, a calandering method, or an extrusion method; and
then including the non-stick film in the multilayer stack.

9. The method of claim 1, wherein the metal substrate comprises stainless steel and the non-stick film comprises PTFE and a filler.

10. The method of claim 1, wherein no mesh layer is included in the multilayer stack.

11. A cooking utensil, comprising:
a laminate comprising a stainless steel substrate directly bonded to a non-stick film,
wherein the non-stick film has a thickness greater than 0.002 inches to less than 0.015 inches.

12. The cooking utensil of claim 11, wherein the thickness of the non-stick film is from about 0.003 inches to about 0.009 inches.

13. The cooking utensil of claim 11, wherein the non-stick film is non-porous.

14. The cooking utensil of claim 11, wherein the non-stick film is free from solvent.

15. The cooking utensil of claim 11, wherein no mesh layer is included in the non-stick film.

16. The cooking utensil of claim 11, wherein the non-stick film comprises PTFE and a filler.

17. A method of making a laminate for a cooking utensil, comprising:
forming a plurality of multilayer stacks, each comprising a non-stick film and a metal substrate,
stacking the plurality of multilayer stacks in a thickness direction and providing a separator comprising a stainless steel disc between adjacent multilayer stacks,
applying pressure to the plurality of multilayer stacks at room temperature, and
subsequently heating the plurality of multilayer stacks to form each multilayer stack into a laminate.

18. The method of claim 17, where the pressure applied is within a range of about 50 bar to about 1000 bar.

19. The method of claim 17, wherein the heating is conducted for a period of about 90 minutes to about 810 minutes.

20. The method of claim 17, wherein the separator further includes a coating layer comprising at least one of a ceramic or a polyimide.
